(19) United States
(12) Patent Application Publication
(10) Pub. No.: US 2010/0030706 A1
(43) Pub. Date: Feb. 4, 2010

(54) EFFICIENT AUCTIONING OF ELECTRONIC BILLBOARDS BY USING TRAFFIC ESTIMATION DATA FROM MOBILE PHONE SERVICE

(75) Inventors: Ramakrishnan Kannan, Tamilnadu (IN); Rajan Ravindran, Karnataka (IN); Anbazhagan Mani, Karnataka (IN); Vasu Vallabhaneni, Austin, TX (US)

Correspondence Address: IBM CORPORATION (ACCSP);c/o Suiter Swantz pc llo, 14301 FNB Parkway, Suite 220, Omaha, NE, 68154, US

(73) Assignees: Ramakrishnan Kannan, Tamilnadu (IN); Rajan Ravindran, Bangalore (IN); Anbazhagan Mani, Bangalore (IN); Vasu Vallabhaneni, Austin, TX (US)

(21) Appl. No.: 12/181,758

(22) Filed: Jul. 29, 2008

(51) Int. Cl. G06Q 30/00; G06Q 10/00; G08G 1/01

(52) U.S. Cl. 705/400

(57) ABSTRACT

The present disclosure is a method for determining an auction reserve price for a display time slot on a billboard. The method may comprise requesting traffic information of an area in proximity of the location of the billboard from a mobile phone service provider and determining the auction reserve price for the display time slot utilizing a pricing model based on the traffic information.

### TECHNICAL FIELD

The present disclosure generally relates to the field of electronics, such as electronic advertising.

### BACKGROUND

Billboards are designed for advertising a product or service, and are typically installed alongside roads. The billboards target commuters and pedestrians. The technology of billboards is maturing from traditional billboards to digital billboards.

In the case of electronic billboards, since the advertisement content (usually text but can also include pictures) can be changed dynamically, there is a need for dynamic pricing and efficient auctioning based on the amount of target audience.

This technology allows users to directly place their advertisements (ads) in the digital billboards through a web browser. In the case of electronic billboards, since the advertisement content can be changed dynamically, there is a need for efficient auctioning of electronic billboards.

### SUMMARY

The present disclosure describes a method for determining an auction reserve price for a display time slot on a billboard. The method may comprise requesting traffic information of an area in proximity of the location of the billboard from a mobile phone service provider and determining the auction reserve price for the display time slot utilizing a pricing model based on the traffic information.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for determining an auction reserve price.

### DETAILED DESCRIPTION

Reference will now be made in detail to the subject matter disclosed, which is illustrated in the accompanying drawings.

Advertisement content of electronic billboards (e-billboards) may change dynamically, thus there is a need for efficient auctioning of electronic billboards by using traffic estimation data. For example, in Times Square, NY during a New Year's Eve bash, there could be ˜1 million people watching an e-billboard. However, during some other time period (slot), only 10,000 people may be watching the same e-billboard. To demonstrate dynamic pricing, during New Year's Eve, a 5 minute advertisement on the e-billboard may cost $10,000. However, during non-peak time periods, it may cost $2,000.

Typically, these billboards are auctioned through websites. The billboard auctioneer may conduct an auction from 08:00-08:30 AM for the ad to be displayed on 09:00 AM. The winning vendor will pay the money online and give the content of the ad in the website which then gets displayed in the billboard using networking technologies.

This introduces a new challenge for the billboard auctioneer in determining the reserve price (i.e. the minimum price for the auction.) The bidder needs to bid more than the reserve price. Today the reserve price is static towards the reservation of billboards. The human time required towards the analysis for fixing up the reserve price is high and may not be very effective.

Billboards are being installed mainly in cities where the mobile phone usage is very high. The present disclosure is directed to an algorithm for determining a reserve price of billboards based on the traffic estimation through cell phone/mobile phone service providers. Mobile Phone service providers have mobile stations/towers adjacent to roads which have been used to calculate traffic information. In some cities, the ratio of “people to mobile phones” may be available, which may be used for more accurate calculations.

Billboards may be auctioned through online resources (e.g., a web portal). For example, a billboard auctioneer may conduct an auction for a predetermined period of time with a reserve price and estimated traffic (based on the real time cell phone data and historic data) for the time period. A vendor may place a bid for the time period being auctioned by specifying an amount greater than the reserve price based on the estimated traffic. The auction ends after the predetermined period of time, and the vendor with the highest bid will be asked to make a payment and provide the content of the advertisement (e.g., through a web portal, or a text message), which then gets displayed on the billboard at a given time specified in the auction.

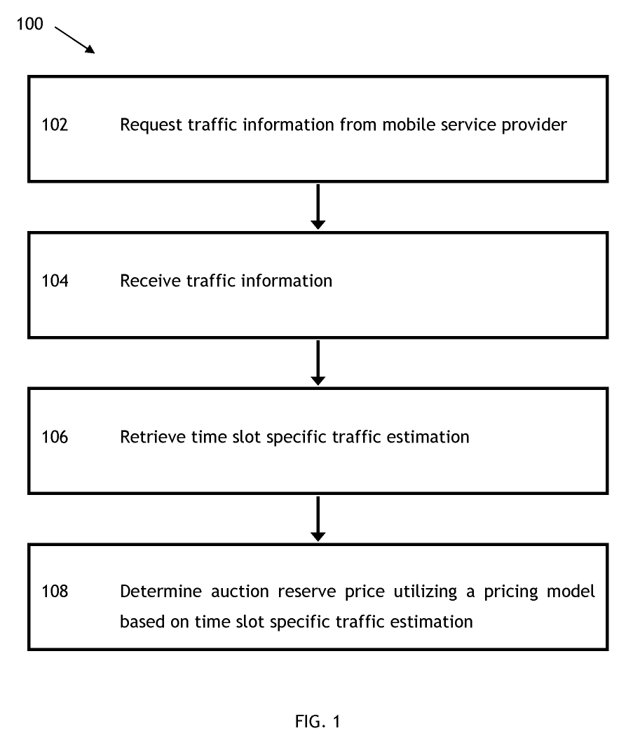

In one embodiment, the estimated traffic information is utilized as a parameter for the determination of the reserve price. FIG. 1 shows a flow diagram illustrating the basic steps performed by a method 100 for determining an auction reserve price for a particular display time slot on a billboard in accordance with the present invention. Step 102 requests from at least one mobile service provider for a data set comprising traffic information of an area where the billboard is located. The traffic information may include the current traffic data, the estimated traffic data, and the past historic traffic data. Step 104 receives the traffic information data set, which is processed by step 106 to retrieve a time slot specific traffic estimation. For example, when conducting auction from 08:00-08:30 AM for the ad to be displayed on 09:00 AM, step 106 would retrieve traffic estimation from the data set that is specific to the time slot of 9:00 AM. Step 108 determines the auction reserve price utilizing a pricing model based on the time slot specific traffic estimation retrieved from step 106. The auction reserve price may be provided to vendors through the web portal, which may also contain information regarding the billboard location details, current traffic, estimated traffic, past historic traffic, auction start time, auction end time, and available time slots.

It is understood that the pricing model may be based on multiple factors. In one embodiment, historic prices are considered in conjunction with the traffic information obtained from the mobile service providers. It is contemplated that step 102 may request traffic information from more than one mobile service provider. In one embodiment, an aggregate service provider collects information from multiple mobile service providers. Step 104 receives consolidated information when traffic information is received from more than one mobile service provider.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A computer program product for determining an auction reserve price for a display time slot on a billboard, comprising:
computer usable program code configured to request from at least one mobile service provider a data set comprising traffic information of an area in proximity of the location of said billboard, said traffic information comprises a current traffic data, an estimated traffic data, and a historic traffic data;
computer usable program code configured to receive said data set from said at least one mobile service provider;
computer usable program code configured to retrieve from said data set a time slot specific traffic estimation, wherein said time slot specific traffic estimation indicates an estimated number of people or vehicles in proximity of the location of said billboard; and
computer usable program code configured to determine said auction reserve price for said display time slot utilizing a pricing model, wherein said pricing model is based on said time slot specific traffic estimation and a set of historic prices.
